(19) United States
(12) Patent Application Publication
(10) Pub. No.: US 2025/0330281 A1
(43) Pub. Date: Oct. 23, 2025

(54) WIDE BANDWIDTH RESOURCE UNIT TONE PLAN DESIGNS FOR NEXT-GENERATION WLAN

(71) Applicant: MEDIATEK INC., Hsinchu City (TW)

(72) Inventors: Shengquan HU, San Jose, CA (US); Jianhan LIU, San Jose, CA (US); Thomas Edward PARE, Jr., San Jose, CA (US)

(21) Appl. No.: 18/870,639

(22) PCT Filed: Jun. 8, 2023
(86) PCT No.: PCT/CN2023/099054

§ 371 Date: Nov. 29, 2024

Related U.S. Application Data
(60) Provisional application No. 63/350,707, filed on Jun. 9, 2022.

(51) Int. Cl. H04L 5/00; H04W 28/20; H04W 72/0453

(52) U.S. Cl. CPC H04L 5/0046; H04L 5/0007; H04W 28/20; H04W 72/0453

(57) ABSTRACT

Techniques pertaining to wide bandwidth resource unit (RU) tone plan designs for next-generation wireless local area networks (WLANs) are described. An apparatus (e.g., station (STA)) generates subcarrier indices of a RU tone plan for a wide bandwidth greater than 80 MHz with a subcarrier spacing (SCS) of 78.125 kHz by using a formula. The apparatus then communicates wirelessly in the wide bandwidth.

### CROSS REFERENCE TO RELATED PATENT APPLICATION

The present disclosure is part of a non-provisional patent application claiming the priority benefit of U.S. Provisional Patent Application Nos. 63/350,707, filed 9 Jun. 2022, the content of which herein being incorporated by reference in its entirety.

### TECHNICAL FIELD

The present disclosure is generally related to wireless communications and, more particularly, to wide bandwidth resource unit (RU) tone plan designs for next-generation wireless local area networks (WLANs).

### BACKGROUND

Unless otherwise indicated herein, approaches described in this section are not prior art to the claims listed below and are not admitted as prior art by inclusion in this section.

In wireless communications such as Wi-Fi (or WiFi) in accordance with the Institute of Electrical and Electronics Engineers (IEEE) 802.11 standards, wider bandwidth tends to be an efficient way to achieve higher throughputs for next-generation WLANs. However, at the present time, designs of RU tone plans for wider bandwidths, such as 240 MHz, 480 MHz, 560 MHz and 640 MHz, have yet to be defined. Therefore, there is a need for a solution of wide bandwidth RU tone plan designs for next-generation WLANs.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to wide bandwidth RU tone plan designs for next-generation WLANs.

In one aspect, a method may involve generating subcarrier indices of a RU tone plan for a wide bandwidth greater than 80 MHz with a subcarrier spacing (SCS) of 78.125 kHz by using a formula. The method may also involve communicating wirelessly in the wide bandwidth.

In another aspect, a method may involve generating subcarrier indices of a RU tone plan for a wide bandwidth greater than 80 MHz with a subcarrier spacing (SCS) of 78.125 kHz by using a formula. The method may also involve communicating wirelessly in the wide bandwidth. In an event that the RU tone plan pertains to a 240 MHz bandwidth, the RU tone plan may involve puncturing a contiguous 80 MHz bandwidth from a 320 MHz bandwidth. In an event that the RU tone plan pertains to a 480 MHz bandwidth, the RU tone plan may involve puncturing a contiguous 160 MHz bandwidth from a 640 MHz bandwidth.

In yet another aspect, an apparatus may include a transceiver configured to communicate wirelessly and a processor coupled to the transceiver. The processor may generate subcarrier indices of a RU tone plan for a wide bandwidth greater than 80 MHz with a SCS of 78.125 kHz by using a formula. The processor may communicate, via the transceiver, wirelessly in the wide bandwidth.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of an example design under a proposed scheme in accordance with the present disclosure.

FIG. 8 is a diagram of an example design under a proposed scheme in accordance with the present disclosure.

FIG. 9 is a diagram of an example design under a proposed scheme in accordance with the present disclosure.

FIG. 10 is a diagram of an example design under a proposed scheme in accordance with the present disclosure.

FIG. 11 is a diagram of an example design under a proposed scheme in accordance with the present disclosure.

FIG. 12 is a diagram of an example design under a proposed scheme in accordance with the present disclosure.

FIG. 13 is a block diagram of an example communication system in accordance with an implementation of the present disclosure.

FIG. 14 is a flowchart of an example process in accordance with an implementation of the present disclosure.

FIG. 15 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to wide bandwidth RU tone plan designs for next-generation WLANs. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (rRU) refers to a RU with tones that are continuous (e.g., adjacent to one another) and not interleaved, interlaced or otherwise distributed. Moreover, a 26-tone regular RU may be interchangeably denoted as RU26 (or rRU26), a 52-tone regular RU may be interchangeably denoted as RU52 (or rRU52), a 106-tone regular RU may be interchangeably denoted as RU106 (or rRU106), a 242-tone regular RU may be interchangeably denoted as RU242 (or rRU242), and so on. Moreover, an aggregate (26+52)-tone regular multi-RU (MRU) may be interchangeably denoted as MRU78 (or rMRU78), an aggregate (26+106)-tone regular MRU may be interchangeably denoted as MRU132 (or rMRU132), and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 500 MHz may be interchangeably denoted as BW500 or BW500M, a bandwidth of 520 MHz may be interchangeably denoted as BW520 or BW520M, a bandwidth of 540 MHz may be interchangeably denoted as BW540 or BW540M, a bandwidth of 640 MHz may be interchangeably denoted as BW640 or BW640M.

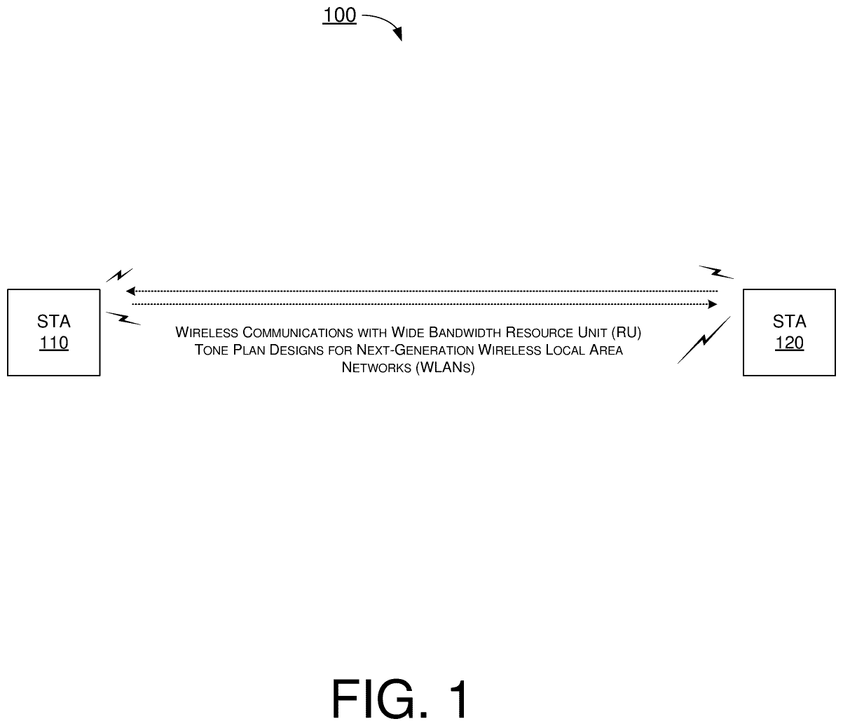

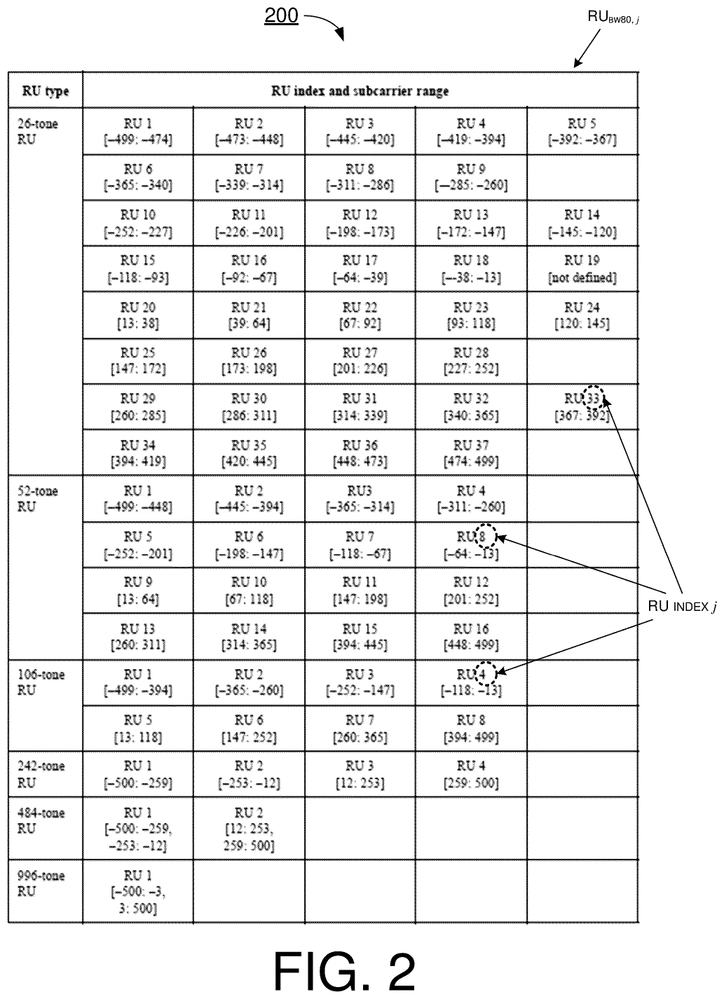

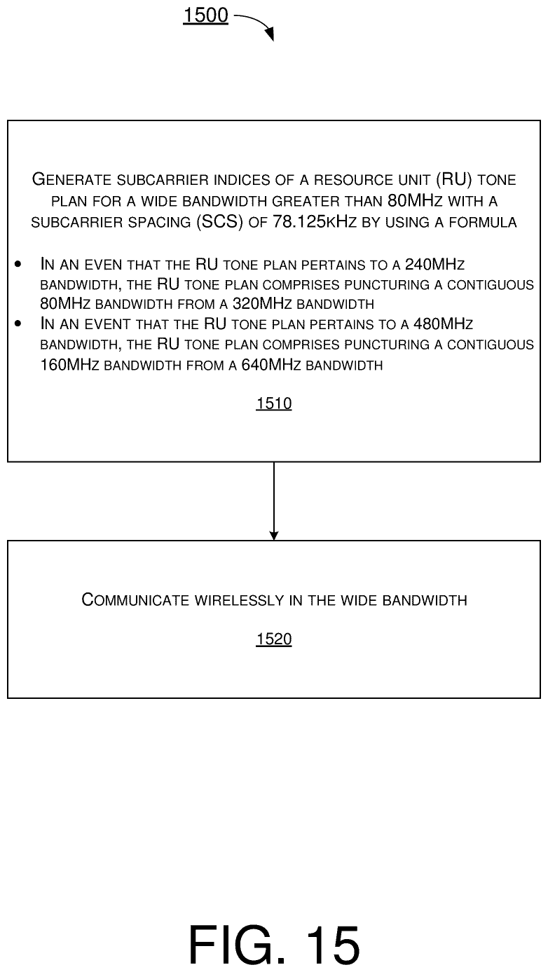

FIG. 1 illustrates an example network environment 100 in which various solutions and schemes in accordance with the present disclosure may be implemented. FIG. 2˜FIG. 15 illustrate examples of implementation of various proposed schemes in network environment 100 in accordance with the present disclosure. The following description of various proposed schemes is provided with reference to FIG. 1˜FIG. 15.

Referring to FIG. 1, network environment 100 may involve at least a station (STA) 110 communicating wirelessly with a STA 120. Either of STA 110 and STA 120 may be a non-access point (non-AP) STA or, alternatively, either of STA 110 and STA 120 may function as an access point (AP) STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the wide bandwidth RU tone plan designs for next-generation WLANs in accordance with various proposed schemes described below. That is, either or both of STA 110 and STA 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under various proposed schemes in accordance with the present disclosure, a RU tone plan of BW80 in IEEE 802.11be may be utilized as a basic building block to generate the RU tone plan for wider bandwidths such as BW240, BW480 and BW640. This design may preserve the RU hierarchical structure as in IEEE 802.11ax/be. Under the proposed schemes, with RU_{bw80} representing the RU tone plan in BW80 in IEEE 802.11be, the RU tone plan for a wide bandwidth>80 MHz with a subcarrier spacing (SCS)=78.125 kHz may be generated as follows: RU_{bw80}+512+n*1024. Here, n=−1, 0 for BW160; n=−1.5, −0.5, 0.5 for BW240; n=−2, −1, 0, 1 for BW320; n=−3, −2, −1, 0, 1, 2 for BW480; and n=−4, −3, −2, −1, 0, 1, 2, 3 for BW640. That is, by assuming SCS 15=78.125 kHz, RU subcarrier indices for a give RU type may be generated for a wide bandwidth>80 MHz as follows:

$$R {U}_{w bw , i} = R {U}_{bw 80 , j} + 5 \; 12 + n * 1024$$

Here, i=1, 2, 3, 4, . . . , N_{ru,bw} and denotes the RU index for a wider bandwidth; j=mod (i−1, N_{ru,bw80})+1 and denotes the RU index for BW80;

$$n = ⌊ \frac{i - 1}{{N}_{ru , bw 80}} ⌋ - \frac{B W}{2 * 80} ,$$

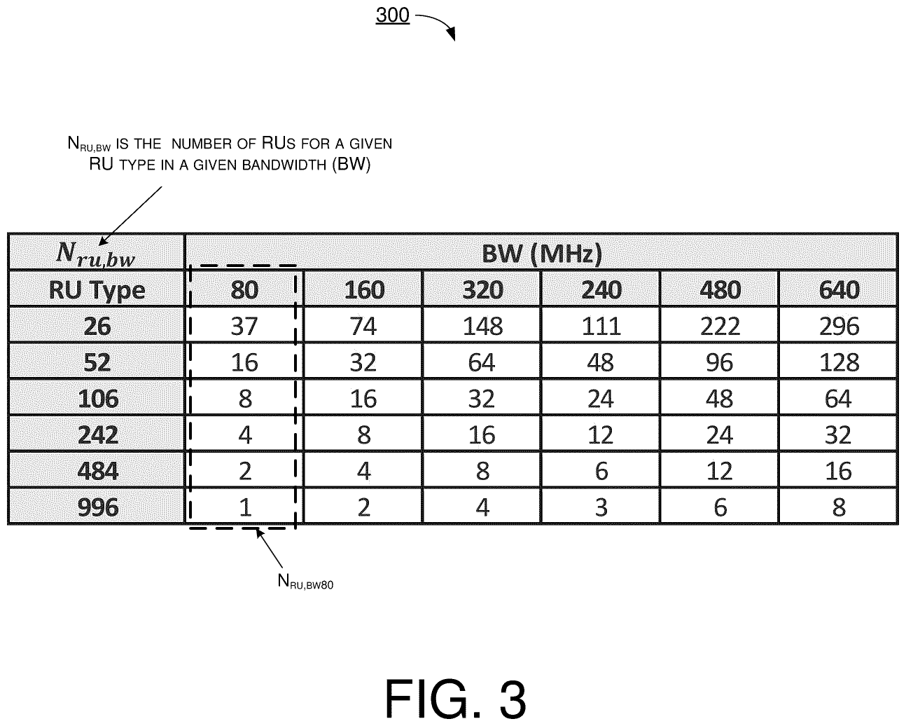

RU_{bw80,j} denotes the RU subcarrier indices as defined in Table 200 shown in FIG. 2 for a given RU size/type in BW80 with RU index j; and N_{ru,bw} denotes the number of RUs for a given RU type in a given bandwidth. Table 300 in FIG. 3 shows N_{ru,bw} for different RU types and different bandwidths. For any given wider bandwidth, RU subcarrier indices (as the style in IEEE 802.11be) may be generated by using the formula-based method, described above, under the proposed scheme.

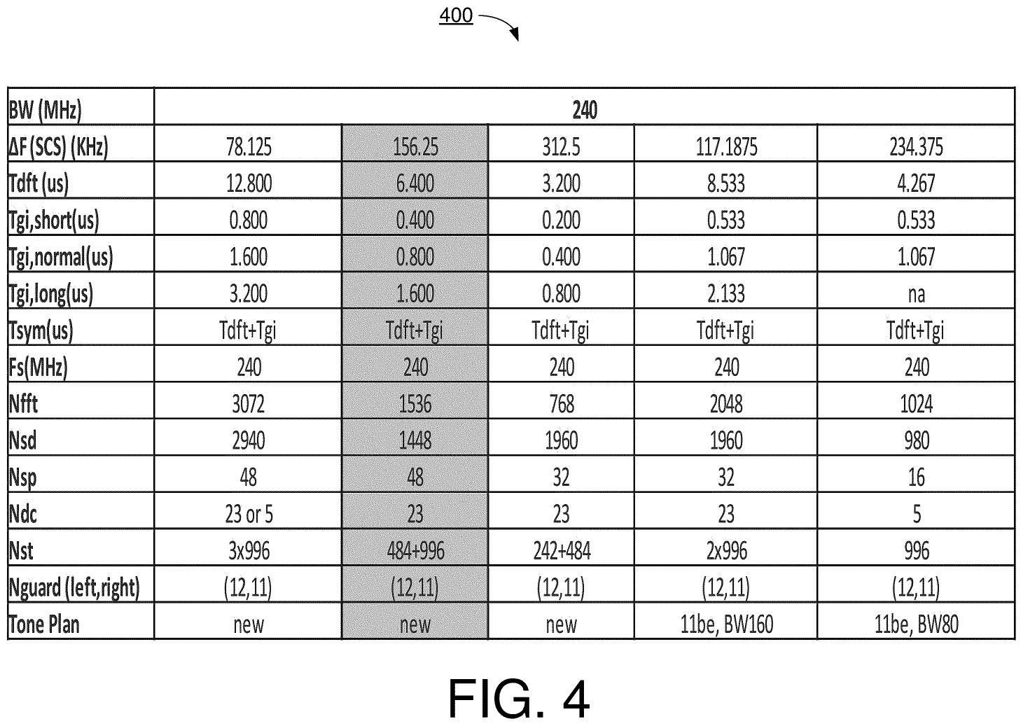

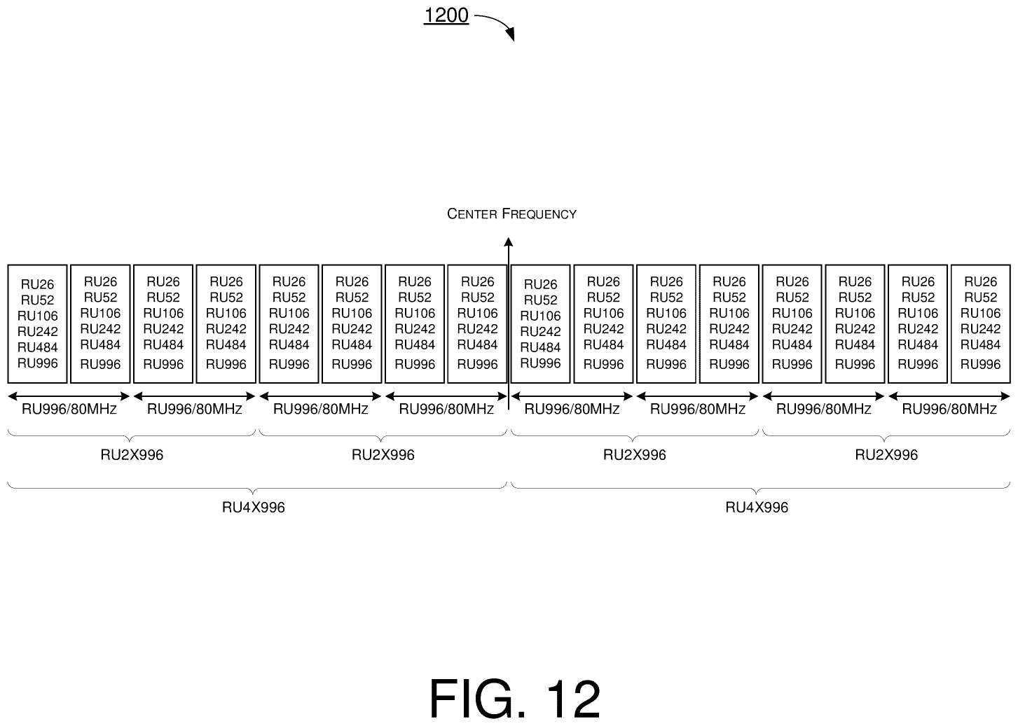

In the various designs described below and shown in some of FIG. 4˜FIG. 12, for each wide bandwidth RU tone plan under each design, pertinent parameters may include, for example and without limitation, ΔF (subcarrier frequency spacing), Taft (discrete Fourier transform (DFT) period), T_{gi, short} (short guard interval (GI) duration), T_{gi,normal} (normal GI duration), T_{gi, long} (long GI duration), T_{sym} (orthogonal frequency-division multiplexing (OFDM) symbol duration), Fₛ (sampling frequency), N_{fft} (number of FFT subcarriers), N_{sd} (number of data-carrying subcarriers), Nₛₚ (number of pilot-tone subcarriers), N_{dc} (number of direct-current (DC) tones), Nₛₜ (total number of subcarriers), and N_{guard} (number of guard tones).

FIG. 4 illustrates an example design 400 under a proposed scheme in accordance with the present disclosure. In design 400, various physical-layer (PHY) parameters and tone plans for 240 MHz may be utilized. Moreover, in design 400, there may be five different options of SCS (and corresponding parameters), namely: 78.125 kHz, 117.1875 kHz, 156.25 kHz, 234.375 kHz and 312.5 kHz.

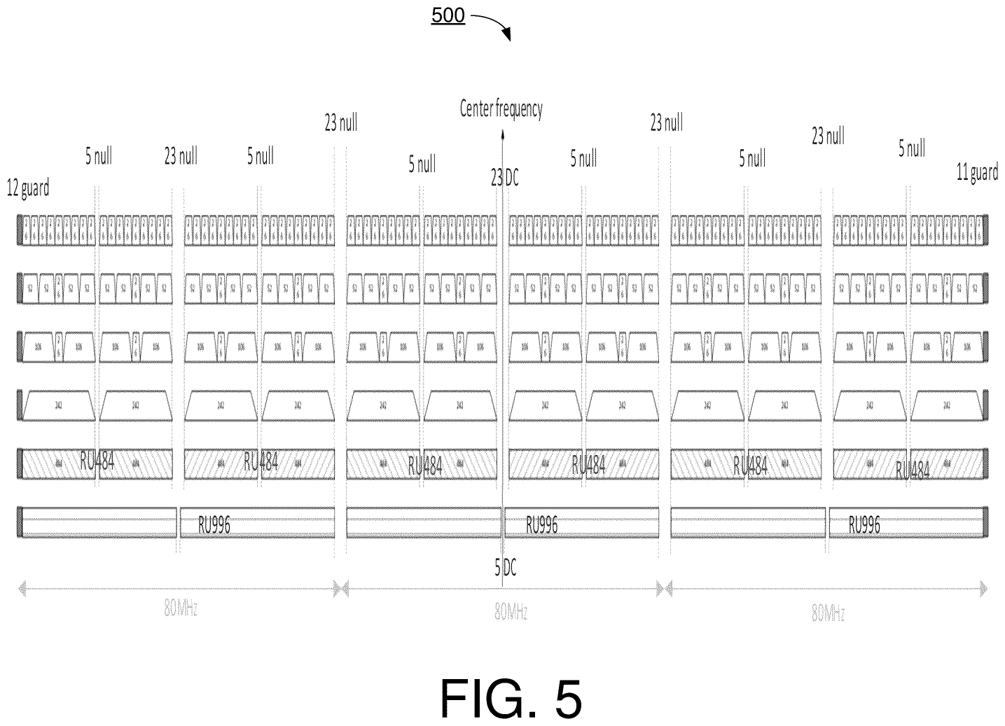

FIG. 5 illustrates an example design 500 under a proposed scheme in accordance with the present disclosure. Design 500 shows a tone plan pertaining to RU allocation for 240 MHz bandwidth. Referring to FIG. 5, design 500 may utilize a SCS of 78.125 kHz with N_{fft}=3072=3*1024=3*2¹⁰. In design 500, the OFDM tone plan may include 108*RU26, 48*RU52, 24*RU106, 12*RU242, 6*RU484, and 3*RU996. Also, in design 500, the non-OFDMA tone plan may include 3*RU996. Moreover, a new RU tone plan may be utilized in design 500.

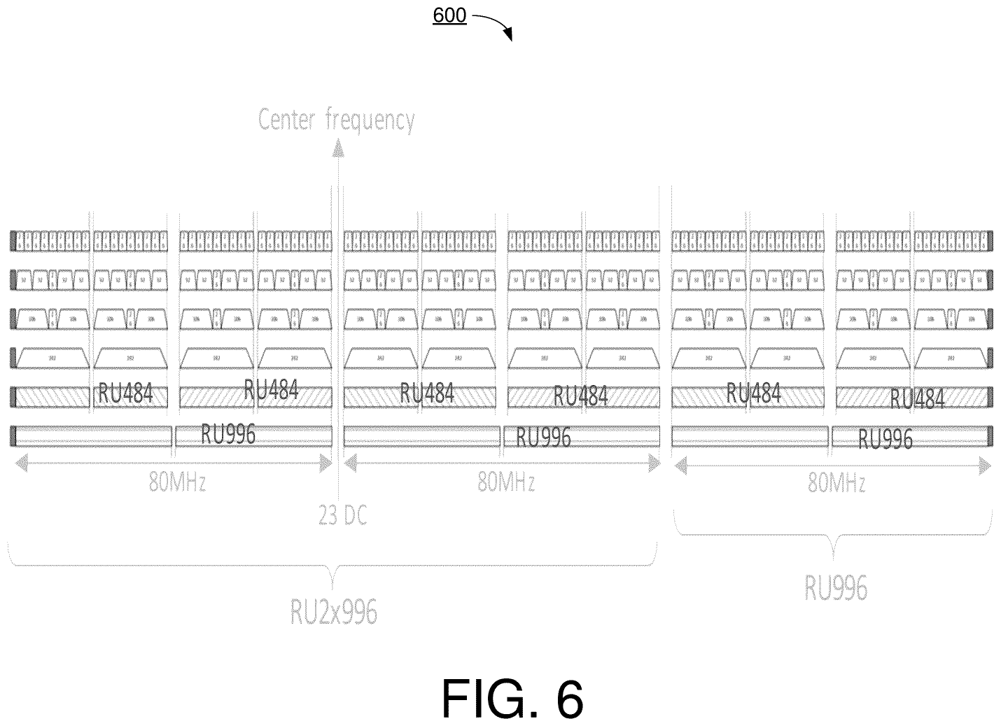

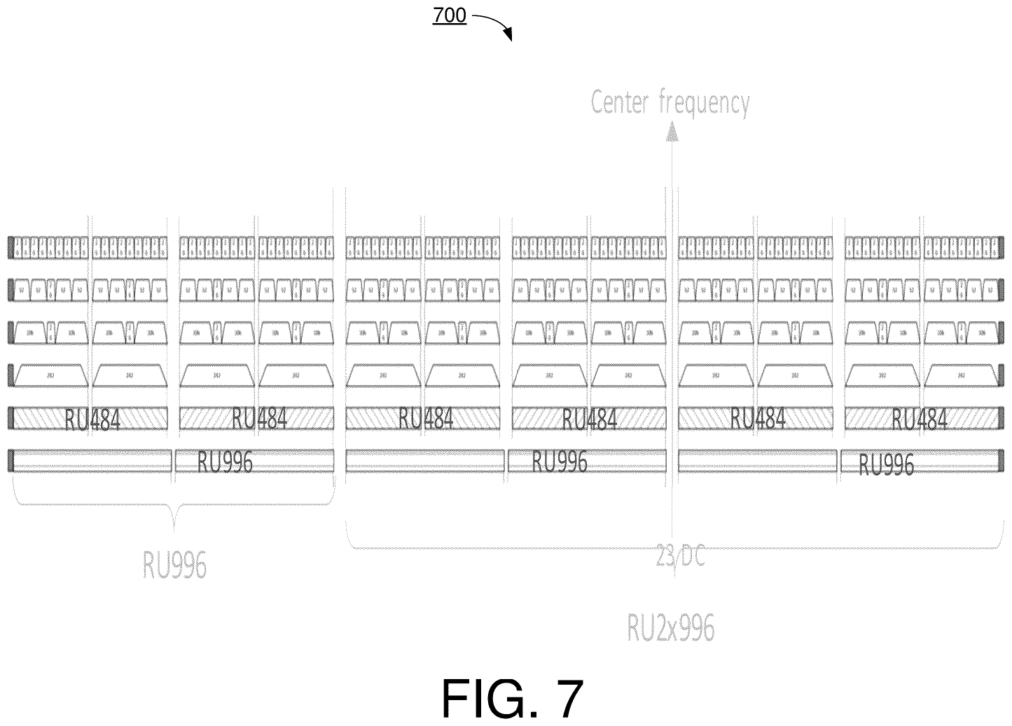

FIG. 6 and FIG. 7 illustrate example designs 600 and 700 under a proposed scheme in accordance with the present disclosure. Design 600 may be one option of tone plan pertaining to RU allocation for 240 MHz bandwidth with SCS=78.125 kHz, and design 700 may be another option of tone plan pertaining to RU allocation for 240 MHz bandwidth with SCS=78.125 kHz. Referring to FIG. 6, in design 600, the center frequency may be the frequency between two 80 MHz segments on the left that constitute RU2×996. Referring to FIG. 7, in design 700, the center frequency may be the frequency between two 80 MHz segments on the right that constitute RU2×996. FIG. 6 and FIG. 7 show that the RU tone plan for BW240 may be considered as puncturing a contiguous 80 MHz bandwidth from a 320 MHz bandwidth.

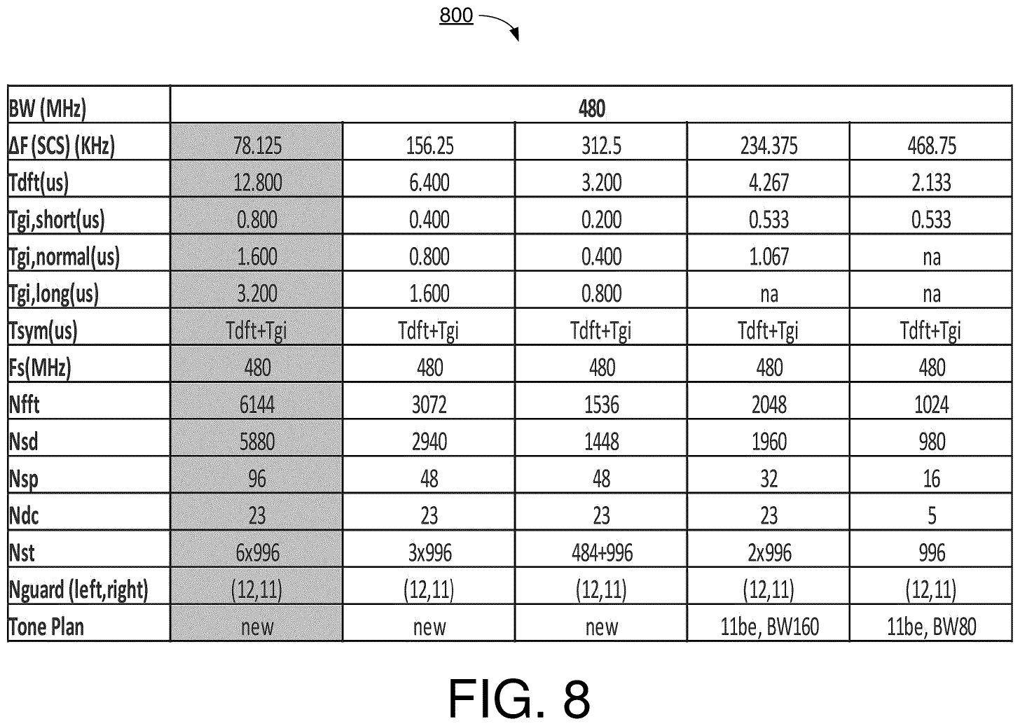

FIG. 8 illustrates an example design 800 under a proposed scheme in accordance with the present disclosure. In design 800, various PHY parameters and tone plans for 480 MHz may be utilized. Moreover, in design 800, there may be five different options of SCS (and corresponding parameters), namely: 78.125 kHz, 156.25 kHz, 234.375 kHz, 312.5 kHz and 468.75 kHz. For SCS=312.5 kHz, the RU tone plan of BW240 with SCS=156.25 kHz may be reused.

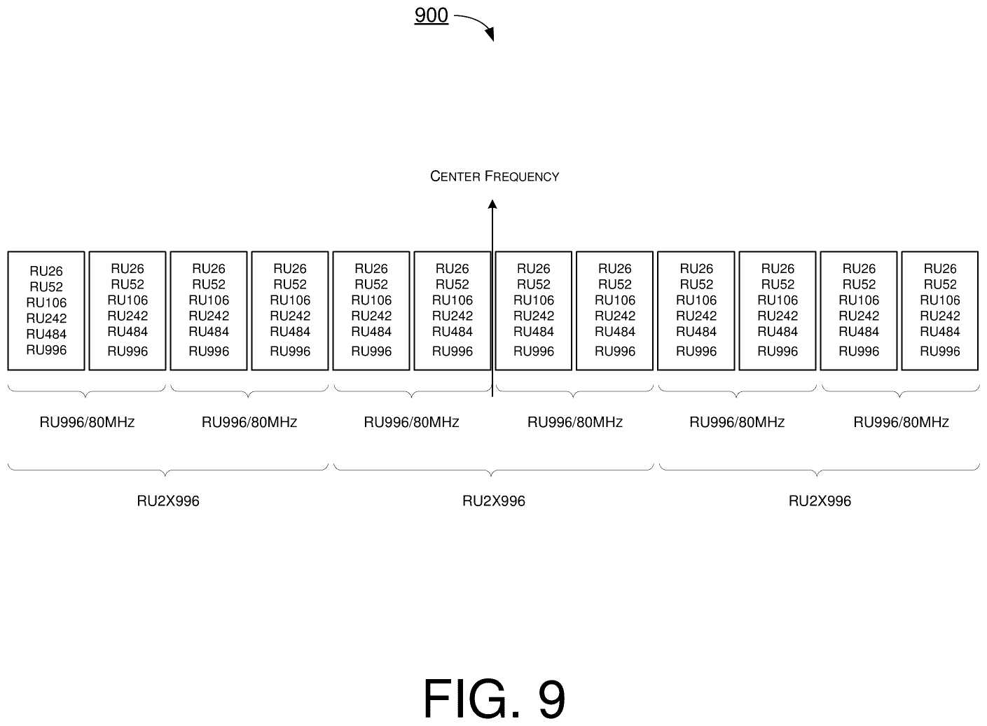

FIG. 9 illustrates an example design 900 under a proposed scheme in accordance with the present disclosure. Design 900 may pertain to of a tone plan of RU allocation for 480 MHz bandwidth. Referring to FIG. 9, design 900 may utilize a SCS of 78.125 kHz with N_{fft}=6144=3*2048=3*212. In design 900, the OFDM tone plan may include 216*RU26, 96*RU52, 48*RU106, 24*RU242, 12*RU484, 6*RU996 and 3*RU2×996. Also, in design 900, the non-OFDMA tone plan may include 6*RU996. It is noteworthy that, for RU2×996, the subcarrier indices may be generated from two corresponding RU996. For instance, the first RU2×996 may be constructed from the first RU996 and the second RU996. Moreover, the second RU2×996 may be constructed from the third RU996 and the fourth RU996. Furthermore, the third RU2×996 may be constructed from the fifth RU996 and the sixth RU996.

Under a proposed scheme in accordance with the present disclosure, with SCS=78.125 kHz, subcarrier indices for 26-tone RUs in BW480 may be generated as follows (with i=1:222, not defined for i=19, 56, 93, 130, 167, 204):

$$R U 2 {6}_{bw 480 , i} = R U 2 {6}_{bw 80 j} + 5 \; 12 + n * 1024$$

Here, i=1, 2, 3, 4, . . . , 222 and denotes the RU index for BW480; j=mod (i−1, 37)+1 and denotes the RU index for BW80;

$$n = ⌊ \frac{i - 1}{37} ⌋ - 3.$$

Under a proposed scheme in accordance with the present disclosure, with SCS=78.125 kHz, subcarrier indices for 52-tone RUs in BW480 may be generated as follows (with i=1:96):

$$R U 5 {2}_{bw 480 , i} = R U 5 {2}_{bw 80 , j} + 5 \; 12 + n * 1024$$

Here, i=1, 2, 3, 4, . . . , 96 and denotes the RU index for BW480; j=mod (i−1, 16)+1 and denotes the RU index for BW80;

$$n = ⌊ \frac{i - 1}{16} ⌋ - 3.$$

Under a proposed scheme in accordance with the present disclosure, with SCS=78.125 kHz, subcarrier indices for 106-tone RUs in BW480 may be generated as follows (with i=1:48):

$$R U 10 {6}_{bw 480 , i} = R U 10 {6}_{bw 80 , j} + 5 \; 12 + n * 1024$$

Here, i=1, 2, 3, 4, . . . , 48 and denotes the RU index for BW480; j=mod (i−1, 8)+1 and denotes the RU index for BW80;

$$n = ⌊ \frac{i - 1}{8} ⌋ - 3.$$

Under a proposed scheme in accordance with the present disclosure, with SCS=78.125 kHz, subcarrier indices for 242-tone RUs in BW480 may be generated as follows (with i=1:24):

$$R U 24 {2}_{bw 480 , i} = R U 24 {2}_{bw 80 , j} + 5 \; 12 + n * 1024$$

Here, i=1, 2, 3, 4, . . . , 24 and denotes the RU index for BW480; j=mod (i−1, 4)+1 and denotes the RU index for BW80;

$$n = ⌊ \frac{i - 1}{4} ⌋ - 3.$$

Under a proposed scheme in accordance with the present disclosure, with SCS=78.125 kHz, subcarrier indices for 484-tone RUs in BW480 may be generated as follows (with i=1:12):

RU484_{bw480,i}=RU484_{bw80,j}+512+n*1024

Here, i=1, 2, 3, 4, . . . , 12 and denotes the RU index for BW480; j=mod(i−1, 2)+1 and denotes the RU index for BW80;

$$n = ⌊ \frac{i - 1}{2} ⌋ - 3.$$

Under a proposed scheme in accordance with the present disclosure, with SCS=78.125 kHz, subcarrier indices for 996-tone RUs in BW480 may be generated as follows (with i=1:6):

$$R U 99 {6}_{bw 480 , i} = R U 99 {6}_{bw 80 , j} + 5 \; 12 + n * 1024$$

Here, i=1, 2, 3, 4, . . . , 6 and denotes the RU index for BW480; j=mod(i−1, 1)+1 or j=i and denotes the RU index for BW80;

$$n = ⌊ \frac{i - 1}{1} ⌋ - 3$$

or n=i−4.

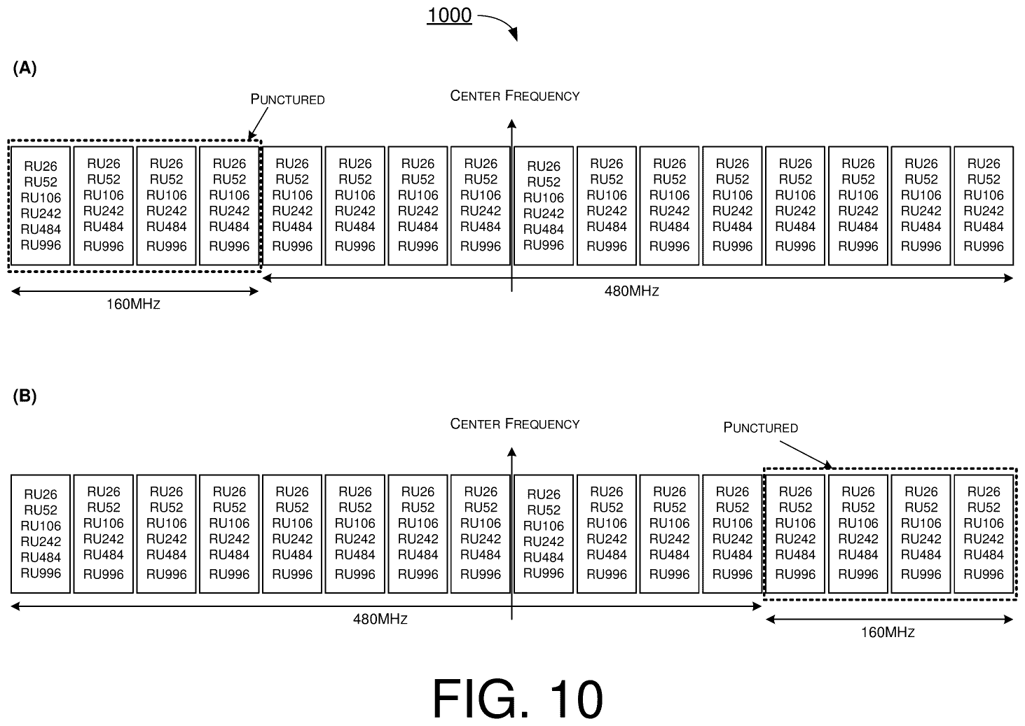

FIG. 10 illustrates an example design 1000 under a proposed scheme in accordance with the present disclosure. Design 1000 may be an alternative option of tone plan pertaining to RU allocation for 480 MHz bandwidth with SCS=78.125 kHz. In design 1000, the RU tone plan for BW480 may be considered as puncturing a contiguous 160 MHz bandwidth from a 640 MHz bandwidth. Part (A) of FIG. 10 shows an example of the RU tone plan for BW480 with a left-most 160 MHz punctured in a tone plan for BW640. Part (B) of FIG. 10 shows another example of the RU tone plan for BW480 with a right-most 160 MHz punctured in the tone plan for BW640.

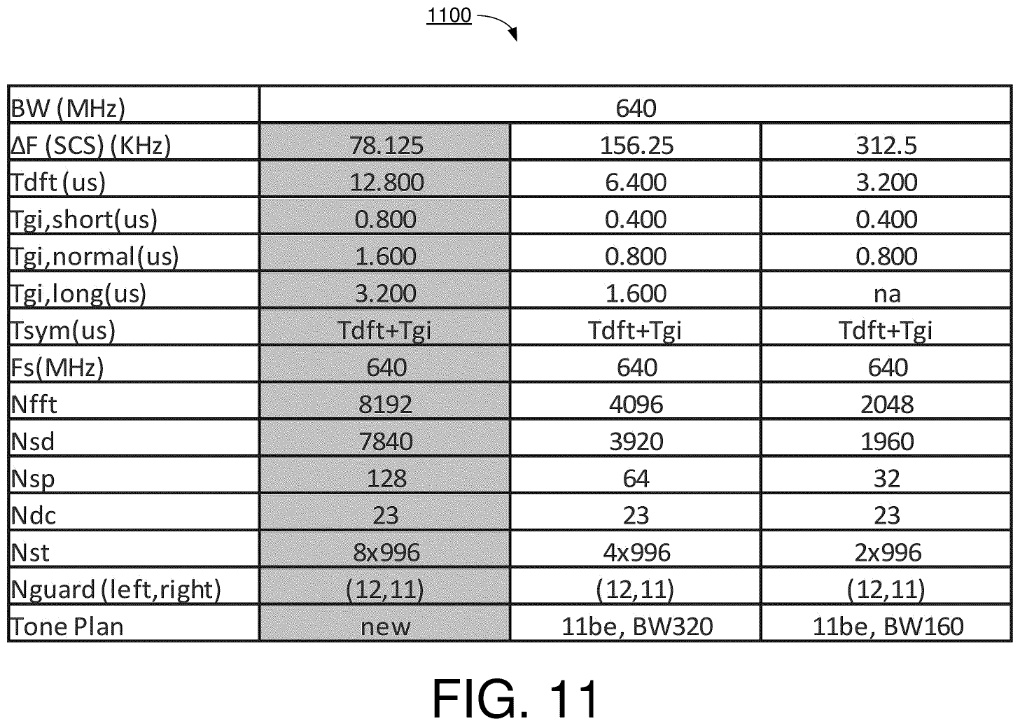

FIG. 11 illustrates an example design 1100 under a proposed scheme in accordance with the present disclosure. In design 1100, various PHY parameters and tone plans for 640 MHz may be utilized. Moreover, in design 1100, there may be three different options of SCS (and corresponding parameters), namely: 78.125 kHz, 156.25 kHz and 312.5 kHz.

FIG. 12 illustrates an example design 1200 under a proposed scheme in accordance with the present disclosure. Design 1200 may pertain to of a tone plan of RU allocation for 640 MHz bandwidth. Referring to FIG. 12, design 1200 may utilize a SCS of 78.125 kHz with N_{fft}=8192=2*4096=213. In design 1200, the OFDM tone plan may include 288*RU26, 128*RU52, 64*RU106, 32*RU242, 16*RU484, 8*RU996, 4*RU2x996 and 2*RU4x996. Also, in design 900, the non-OFDMA tone plan may include 8*RU996. It is noteworthy that, for RU2x996 and RU4x996, the subcarrier indices may be generated from two corresponding RU996. For instance, the first RU2x996 may be constructed from the first RU996 and the second RU996. Moreover, the second RU2x996 may be constructed from the third RU996 and the fourth RU996. Furthermore, the third RU2x996 may be constructed from the fifth RU996 and the sixth RU996. Similarly, the first RU4x996 may be constructed from the first RU2x996 and the second RU2x996. Also, the second RU4x996 may be constructed from the third RU2x996 and the fourth RU2x996.

Under a proposed scheme in accordance with the present disclosure, with SCS=78.125 kHz, subcarrier indices for 26-tone RUs in BW640 may be generated as follows (with i=1:296, not defined for i=19, 56, 93, 130, 167, 204, 241, 278):

$$R U 2 {6}_{bw 640 , i} = R U 2 {6}_{bw 80 , j} + 5 \; 12 + n * 1024$$

Here, i=1, 2, 3, 4, . . . , 296 and denotes the RU index for BW640; j=mod(i−1, 37)+1 and denotes the RU index for BW80;

$$n = ⌊ \frac{i - 1}{37} ⌋ - 4.$$

Under a proposed scheme in accordance with the present disclosure, with SCS=78.125 kHz, subcarrier indices for 52-tone RUs in BW640 may be generated as follows (with i=1:128):

$$R U 5 {2}_{bw 640 , i} = R U 5 {2}_{bw 80 , j} + 5 \; 12 + n * 1024$$

Here, i=1, 2, 3, 4, . . . , 128 and denotes the RU index for BW640; j=mod(i−1, 16)+1 and denotes the RU index for BW80;

$$n = ⌊ \frac{i - 1}{16} ⌋ - 4.$$

Under a proposed scheme in accordance with the present disclosure, with SCS=78.125 kHz, subcarrier indices for 106-tone RUs in BW640 may be generated as follows (with i=1:64):

$$R U 10 {6}_{bw 640 , i} = R U 10 {6}_{bw 80 , j} + 5 \; 12 + n * 1024$$

Here, i=1, 2, 3, 4, . . . , 64 and denotes the RU index for BW640; j=mod(i−1, 8)+1 and denotes the RU index for BW80;

$$n = ⌊ \frac{i - 1}{8} ⌋ - 4.$$

Under a proposed scheme in accordance with the present disclosure, with SCS=78.125 kHz, subcarrier indices for 242-tone RUs in BW640 may be generated as follows (with i=1:32):

$$R U 24 {2}_{bw 640 , i} = R U 24 {2}_{bw 80 , j} + 5 \; 12 + n * 1024$$

Here, i=1, 2, 3, 4, . . . , 32 and denotes the RU index for BW640; j=mod(i−1, 4)+1 and denotes the RU index for BW80;

$$n = ⌊ \frac{i - 1}{4} ⌋ - 4.$$

Under a proposed scheme in accordance with the present disclosure, with SCS=78.125 kHz, subcarrier indices for 484-tone RUs in BW640 may be generated as follows (with i=1:16):

$$R U 48 {4}_{bw 640 , i} = R U 48 {4}_{bw 80 , j} + 5 \; 12 + n * 1024$$

Here, i=1, 2, 3, 4, . . . , 16 and denotes the RU index for BW640; j=mod(i−1, 2)+1 and denotes the RU index for BW80;

$$n = ⌊ \frac{i - 1}{2} ⌋ - 4.$$

Under a proposed scheme in accordance with the present disclosure, with SCS=78.125 kHz, subcarrier indices for 996-tone RUs in BW640 may be generated as follows (with i=1:8):

$$R U 99 {6}_{bw 640 , i} = R U 99 {6}_{bw 80 , j} + 5 \; 12 + n * 1024$$

Here, i=1, 2, 3, 4, . . . , 8 and denotes the RU index for BW640; j=mod(i−1, 1)+1 or j=i and denotes the RU index for BW80; or n=i−5.

$$n = ⌊ \frac{i - 1}{1} ⌋ - 4$$

### Illustrative Implementations

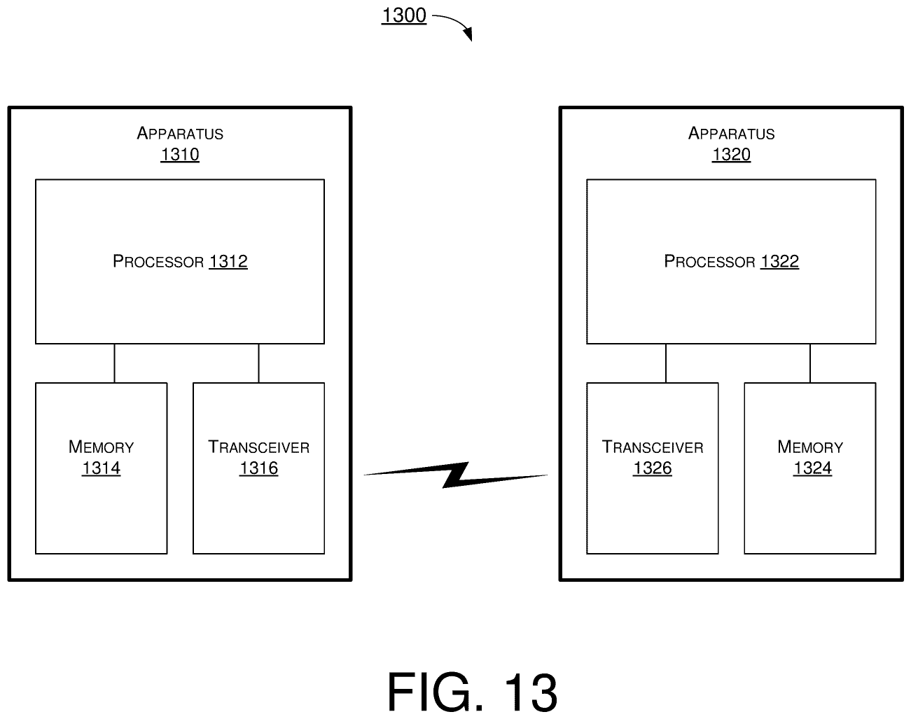

FIG. 13 illustrates an example system 1300 having at least an example apparatus 1310 and an example apparatus 1320 in accordance with an implementation of the present disclosure. Each of apparatus 1310 and apparatus 1320 may perform various functions to implement schemes, techniques, processes and methods described herein pertaining to wide bandwidth RU tone plan designs for next-generation WLANs, including the various schemes described above with respect to various proposed designs, concepts, schemes, systems and methods described above as well as processes described below. For instance, apparatus 1310 may be implemented in STA 110 and apparatus 1320 may be implemented in STA 120, or vice versa.

Each of apparatus 1310 and apparatus 1320 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 1310 and apparatus 1320 may be implemented in a smartphone, a smart watch, a personal digital assistant, a digital camera, or a computing equipment such as a tablet computer, a laptop computer or a notebook computer. Each of apparatus 1310 and apparatus 1320 may also be a part of a machine type apparatus, which may be an IoT apparatus such as an immobile or a stationary apparatus, a home apparatus, a wire communication apparatus or a computing apparatus. For instance, each of apparatus 1310 and apparatus 1320 may be implemented in a smart thermostat, a smart fridge, a smart door lock, a wireless speaker or a home control center. When implemented in or as a network apparatus, apparatus 1310 and/or apparatus 1320 may be implemented in a network node, such as an AP in a WLAN.

In some implementations, each of apparatus 1310 and apparatus 1320 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1310 and apparatus 1320 may be implemented in or as a STA or an AP. Each of apparatus 1310 and apparatus 1320 may include at least some of those components shown in FIG. 13 such as a processor 1312 and a processor 1322, respectively, for example. Each of apparatus 1310 and apparatus 1320 may further include one or more other components not pertinent to the proposed scheme of the present disclosure (e.g., internal power supply, display device and/or user interface device), and, thus, such component(s) of apparatus 1310 and apparatus 1320 are neither shown in FIG. 13 nor described below in the interest of simplicity and brevity.

In one aspect, each of processor 1312 and processor 1322 may be implemented in the form of one or more single-core processors, one or more multi-core processors, one or more RISC processors or one or more CISC processors. That is, even though a singular term “a processor” is used herein to refer to processor 1312 and processor 1322, each of processor 1312 and processor 1322 may include multiple processors in some implementations and a single processor in other implementations in accordance with the present disclosure. In another aspect, each of processor 1312 and processor 1322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1312 and processor 1322 is a special-purpose machine specifically designed, arranged and configured to perform specific tasks including those pertaining to wide bandwidth RU tone plan designs for next-generation WLANs in accordance with various implementations of the present disclosure.

In some implementations, apparatus 1310 may also include a transceiver 1316 coupled to processor 1312. Transceiver 1316 may include a transmitter capable of wirelessly transmitting and a receiver capable of wirelessly receiving data. In some implementations, apparatus 1320 may also include a transceiver 1326 coupled to processor 1322. Transceiver 1326 may include a transmitter capable of wirelessly transmitting and a receiver capable of wirelessly receiving data. It is noteworthy that, although transceiver 1316 and transceiver 1326 are illustrated as being external to and separate from processor 1312 and processor 1322, respectively, in some implementations, transceiver 1316 may be an integral part of processor 1312 as a system on chip (SoC), and transceiver 1326 may be an integral part of processor 1322 as a SoC.

In some implementations, apparatus 1310 may further include a memory 1314 coupled to processor 1312 and capable of being accessed by processor 1312 and storing data therein. In some implementations, apparatus 1320 may further include a memory 1324 coupled to processor 1322 and capable of being accessed by processor 1322 and storing data therein. Each of memory 1314 and memory 1324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1314 and memory 1324 may include a type of read-only memory (ROM) such as mask ROM, programmable ROM (PROM), erasable programmable ROM (EPROM) and/or electrically erasable programmable ROM (EEPROM). Alternatively, or additionally, each of memory 1314 and memory 1324 may include a type of non-volatile random-access memory (NVRAM) such as flash memory, solid-state memory, ferroelectric RAM (FeRAM), magnetoresistive RAM (MRAM) and/or phase-change memory.

Each of apparatus 1310 and apparatus 1320 may be a communication entity capable of communicating with each other using various proposed schemes in accordance with the present disclosure. For illustrative purposes and without limitation, a description of capabilities of apparatus 1310, as STA 110, and apparatus 1320, as STA 120, is provided below. It is noteworthy that, although a detailed description of capabilities, functionalities and/or technical features of apparatus 1320 is provided below, the same may be applied to apparatus 1310 although a detailed description thereof is not provided solely in the interest of brevity. It is also noteworthy that, although the example implementations described below are provided in the context of WLAN, the same may be implemented in other types of networks.

Under various proposed schemes pertaining to wide bandwidth RU tone plan designs for next-generation WLANs in accordance with the present disclosure, with apparatus 1310 implemented in or as STA 110 and apparatus 1320 implemented in or as STA 120 in network environment 100, processor 1312 of apparatus 1310 may generate subcarrier indices of a RU tone plan for a wide bandwidth greater than 80 MHz with a SCS of 78.125 kHz by using a formula. Moreover, processor 1312 may communicate, via transceiver 1316, wirelessly in the wide bandwidth (e.g., transmitting to and/or receiving from apparatus 1320).

In some implementations, in generating the subcarrier indices of the RU tone plan for the wide bandwidth, processor 1312 may generate the subcarrier indices as:

$$R {U}_{w bw , i} = R {U}_{bw 80 , j} + 5 \; 12 + n * 1024.$$

In such cases, i=1, 2, 3, 4, . . . , N_{ru,bw} and may denote a RU index for the wide bandwidth, j=mod(i−1, N_{ru,bw80})+1 and may denote a RU index for an 80 MHz bandwidth,

$$n = ⌊ \frac{i - 1}{{N}_{ru , bw 80}} ⌋ - \frac{B W}{2 * 80} ,$$

RU_{wbw,i} may denote subcarrier indices for a respective RU type in the wide bandwidth with a RU index i, RU_{bw80,j} may denote subcarrier indices for a respective RU type in an 80 MHz bandwidth with a RU index j, and N_{ru,bw} may denote a number of RUs for the respective RU type in a respective bandwidth.

In some implementations, in generating the subcarrier indices of the RU tone plan for the wide bandwidth, processor 1312 may generate one or more 26-tone RUs in a 480 MHz bandwidth as:

$$R U 2 {6}_{bw 480 , i} = R U 2 {6}_{bw 80 , j} + 5 \; 12 + n * 1024.$$

In such cases, i=1, 2, 3, 4, . . . , 222, with i=19, 56, 93, 130, 167, 204 not defined, and may denote a RU index for the 480 MHz bandwidth, j=mod(i−1, 37)+1, and

$$n = ⌊ \frac{i - 1}{37} ⌋ - 3.$$

In some implementations, in generating the subcarrier indices of the RU tone plan for the wide bandwidth, processor 1312 may generate one or more 52-tone RUs in a 480 MHz bandwidth as:

$$R U 5 {2}_{bw 480 , i} = R U 5 {2}_{bw 80 , j} + 5 \; 12 + n * 1024.$$

In such cases, i=1, 2, 3, 4, . . . , 96 and may denote a RU index for the 480 MHz bandwidth, j=mod(i−1, 16)+1, and

$$n = ⌊ \frac{i - 1}{16} ⌋ - 3.$$

In some implementations, in generating the subcarrier indices of the RU tone plan for the wide bandwidth, processor 1312 may generate one or more 106-tone RUs in a 480 MHz bandwidth as:

$$R U 10 {6}_{bw 480 , i} = R U 10 {6}_{bw 80 , j} + 5 \; 12 + n * 1024.$$

In such cases, i=1, 2, 3, 4, . . . , 48 and may denote a RU index for the 480 MHz bandwidth, j=mod(i−1,8)+1, and

$$n = ⌊ \frac{i - 1}{8} ⌋ - 3.$$

In some implementations, in generating the subcarrier indices of the RU tone plan for the wide bandwidth, processor 1312 may generate one or more 242-tone RUs in a 480 MHz bandwidth as:

$$R U 24 {2}_{bw 480 , i} = R U 24 {2}_{bw 80 , j} + 5 \; 12 + n * 1024.$$

In such cases, i=1, 2, 3, 4, . . . , 24 and may denote a RU index for the 480 MHz bandwidth, j=mod(i−1, 4)+1, and

$$n = ⌊ \frac{i - 1}{4} ⌋ - 3.$$

In some implementations, in generating the subcarrier indices of the RU tone plan for the wide bandwidth, processor 1312 may generate one or more 484-tone RUs in a 480 MHz bandwidth as:

$$R U 48 {4}_{bw 480 , i} = R U 48 {4}_{bw 80 , j} + 5 \; 12 + n * 1024.$$

In such cases, i=1, 2, 3, 4, . . . , 12 and may denote a RU index for the 480 MHz bandwidth, j=mod(i−1, 2)+1, and

$$n = ⌊ \frac{i - 1}{2} ⌋ - 3.$$

In some implementations, in generating the subcarrier indices of the RU tone plan for the wide bandwidth, processor 1312 may generate one or more 996-tone RUs in a 480 MHz bandwidth as:

$$R U 99 {6}_{bw 480 , i} = R U 99 {6}_{bw 80 , j} + 5 \; 12 + n * 1024.$$

In such cases, i=1, 2, 3, 4, . . . , 6 and may denote a RU index for the 480 MHz bandwidth, j=mod(i−1, 1)+1 or j=i, and or n=i−4.

$$n = ⌊ \frac{i - 1}{1} ⌋ - 3$$

In some implementations, in generating the subcarrier indices of the RU tone plan for the wide bandwidth, processor 1312 may generate one or more 26-tone RUs in a 640 MHz bandwidth as:

$$R U 2 {6}_{b w 640 , i} = R U 2 {6}_{bw 80 , j} + 5 \; 12 + n * 1024.$$

In such cases, i=1, 2, 3, 4, . . . , 296, with i=19, 56, 93, 130, 167, 204, 241, 278 not defined, and may denote a RU index for the 640 MHz bandwidth, j=mod(i−1, 37)+1, and

$$n = ⌊ \frac{i - 1}{37} ⌋ - 4 .$$

In some implementations, in generating the subcarrier indices of the RU tone plan for the wide bandwidth, processor 1312 may generate one or more 52-tone RUs in a 640 MHz bandwidth as:

$$RU {52}_{b w 640 , i} = R U 5 {2}_{bw 80 , j} + 5 \; 12 + n * 1024.$$

In such cases, i=1, 2, 3, 4, . . . , 128 and may denote a RU index for the 640 MHz bandwidth, j=mod(i−1, 16)+1, and

$$n = ⌊ \frac{i - 1}{16} ⌋ - 4.$$

In some implementations, in generating the subcarrier indices of the RU tone plan for the wide bandwidth, processor 1312 may generate one or more 106-tone RUs in a 640 MHz bandwidth as:

$$R U 10 {6}_{b w 640 , i} = R U 10 {6}_{bw 80 , j} + 5 \; 12 + n * 1024.$$

In such cases, i=1, 2, 3, 4, . . . , 64 and may denote a RU index for the 640 MHz bandwidth, j=mod(i−1, 8)+1, and

$$n = ⌊ \frac{i - 1}{8} ⌋ - 4.$$

In some implementations, in generating the subcarrier indices of the RU tone plan for the wide bandwidth, processor 1312 may generate one or more 242-tone RUs in a 640 MHz bandwidth as:

$$R U 24 {2}_{b w 640 , i} = R U 24 {2}_{bw 80 , j} + 5 \; 12 + n * 1024.$$

In such cases, i=1, 2, 3, 4, . . . , 32 and may denote a RU index for the 640 MHz bandwidth, j=mod(i−1, 4)+1, and

$$n = ⌊ \frac{i - 1}{4} ⌋ - 4.$$

In some implementations, in generating the subcarrier indices of the RU tone plan for the wide bandwidth, processor 1312 may generate one or more 484-tone RUs in a 640 MHz bandwidth as:

$$R U 48 {4}_{b w 640 , i} = R U 48 {4}_{bw 80 , j} + 5 \; 12 + n * 1024.$$

In such cases, i=1, 2, 3, 4, . . . , 16 and may denote a RU index for the 640 MHz bandwidth, j=mod(i−1, 2)+1, and

$$n = ⌊ \frac{i - 1}{4} ⌋ - 4.$$

In some implementations, in generating the subcarrier indices of the RU tone plan for the wide bandwidth, processor 1312 may generate one or more 996-tone RUs in a 640 MHz bandwidth as:

$$R U 99 {6}_{b w 640 , i} = R U 99 {6}_{bw 80 , j} + 5 \; 12 + n * 1024.$$

In such cases, i=1, 2, 3, 4, . . . , 8 and may denote a RU index for the 640 MHz bandwidth, j=mod(i−1, 1)+1 or j=i, and or n=i−5.

$$n = ⌊ \frac{i - 1}{4} ⌋ - 4.$$

In some implementations, in communicating, processor 1312 may communicate in a 240 MHz bandwidth and a plurality of parameters. The parameters may include: (a) T_{dft}=12.800 μs; (b) T_{gi,short}=0.800 μs; (c) T_{gi, normal}=1.600 μs; (d) T_{gi, long}=3.200 μs; (e) T_{sym}=T_{dft}+T_{gi}; (f) Fₛ=240 MHz; (g) N_{fft}=3072; (h) N_{sd}=2940; (i) Nₛₚ=48; (j) N_{dc}=23 or 5; (k) Nₛₜ=3*996; and (1) N_{guard}=(12, 11).

In some implementations, in communicating, processor 1312 may communicate in a 480 MHz bandwidth and a plurality of parameters. The parameters may include: (a) T_{dft}=12.800 μs; (b) T_{gi,short}=0.800 μs; (c) T_{gi, normal}=1.600 μs; (d) T_{gi, long}=3.200 μs; (e) T_{sym}=T_{dft}+T_{gi}; (f) Fₛ=480 MHz; (g) N_{fft}=6144; (h) N_{sd}=5880; (i) Nₛₚ=96; (j) N_{dc}=23; (k) Nₛₜ=6*996; and (1) N_{guard}=(12, 11).

In some implementations, in communicating, processor 1312 may communicate in a 480 MHz bandwidth and a plurality of parameters. The parameters may include: (a) T_{dft}=12.800 μs; (b) T_{gi,short}=0.800 μs; (c) T_{gi, normal}=1.600 μs; (d) T_{gi, long}=3.200 μs; (e) T_{sym}=T_{dft}+T_{gi}; (f) Fₛ=640 MHz; (g) N_{fft}=8192; (h) N_{sd}=7840; (i) Nₛₚ=128; (j) N_{dc}=23; (k) Nₛₜ=8*996; and (1) N_{guard}=(12, 11).

### Illustrative Processes

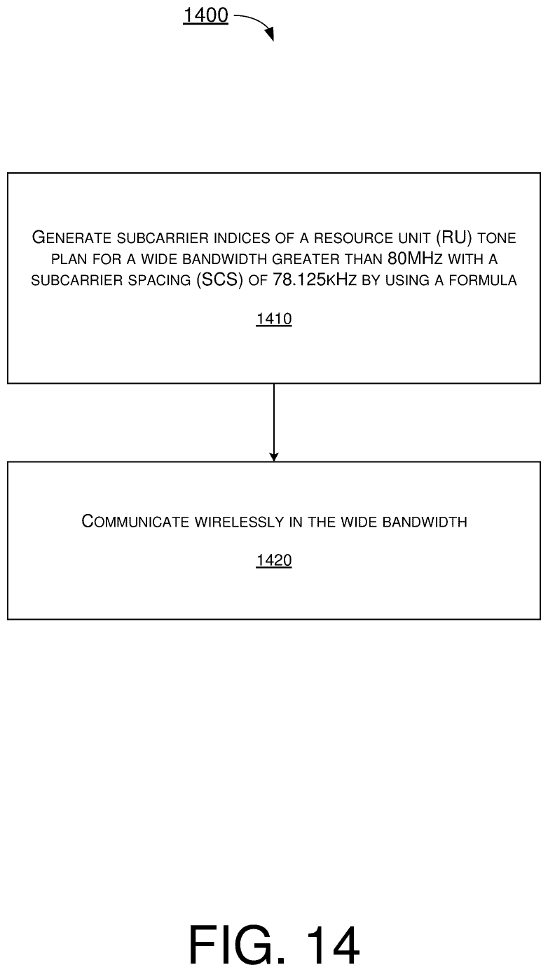

FIG. 14 illustrates an example process 1400 in accordance with an implementation of the present disclosure. Process 1400 may represent an aspect of implementing various proposed designs, concepts, schemes, systems and methods described above. More specifically, process 1400 may represent an aspect of the proposed concepts and schemes pertaining to wide bandwidth RU tone plan designs for next-generation WLANs in accordance with the present disclosure. Process 1400 may include one or more operations, actions, or functions as illustrated by one or more of blocks 1410 and 1420. Although illustrated as discrete blocks, various blocks of process 1400 may be divided into additional blocks, combined into fewer blocks, or eliminated, depending on the desired implementation. Moreover, the blocks/sub-blocks of process 1400 may be executed in the order shown in FIG. 14 or, alternatively in a different order. Furthermore, one or more of the blocks/sub-blocks of process 1400 may be executed repeatedly or iteratively. Process 1400 may be implemented by or in apparatus 1310 and apparatus 1320 as well as any variations thereof. Solely for illustrative purposes and without limiting the scope, process 1400 is described below in the context of apparatus 1310 implemented in or as STA 110 functioning as a non-AP STA and apparatus 1320 implemented in or as STA 120 functioning as an AP STA of a wireless network such as a WLAN in network environment 100 in accordance with one or more of IEEE 802.11 standards. Process 1400 may begin at block 1410.

At 1410, process 1400 may involve processor 1312 of apparatus 1310 generating subcarrier indices of a RU tone plan for a wide bandwidth greater than 80 MHz with a SCS of 78.125 kHz by using a formula. Process 1400 may proceed from 1410 to 1420.

At 1420, process 1400 may involve processor 1312 communicating, via transceiver 1316, wirelessly in the wide bandwidth (e.g., transmitting to and/or receiving from apparatus 1320).

In some implementations, in generating the subcarrier indices of the RU tone plan for the wide bandwidth, process 1400 may involve processor 1312 generating the subcarrier indices as:

$$R {U}_{wbw , i} = R {U}_{bw 80 , j} + 5 \; 12 + n * 1024.$$

In such cases, i=1, 2, 3, 4, . . . , N_{ru,bw} and may denote a RU index for the wide bandwidth, j=mod(i−1, N_{ru,bw80})+1 and may denote a RU index for an 80 MHz bandwidth,

$$n = ⌊ \frac{i - 1}{{N}_{ru , bw 80}} ⌋ - \frac{B W}{2 * 80} ,$$

RU_{wbw,i} may denote subcarrier indices for a respective RU type in the wide bandwidth with a RU index i, RU_{bw80,j} may denote subcarrier indices for a respective RU type in an 80 MHz bandwidth with a RU index j, and N_{ru,bw} may denote a number of RUs for the respective RU type in a respective bandwidth.

In some implementations, in generating the subcarrier indices of the RU tone plan for the wide bandwidth, process 1400 may involve processor 1312 generating one or more 26-tone RUs in a 480 MHz bandwidth as:

$$R U 2 {6}_{bw 480 , i} = R U 2 {6}_{bw 80 , j} + 5 \; 12 + n * 1024.$$

In such cases, i=1, 2, 3, 4, . . . , 222, with i=19, 56, 93, 130, 167, 204 not defined, and may denote a RU index for the 480 MHz bandwidth, j=mod(i−1, 37)+1, and

$$n = ⌊ \frac{i - 1}{37} ⌋ - 3.$$

In some implementations, in generating the subcarrier indices of the RU tone plan for the wide bandwidth, process 1400 may involve processor 1312 generating one or more 52-tone RUs in a 480 MHz bandwidth as:

$$R U 5 {2}_{bw 480 , i} = R U 5 {2}_{bw 80 , j} + 5 \; 12 + n * 1024.$$

In such cases, i=1, 2, 3, 4, . . . , 96 and may denote a RU index for the 480 MHz bandwidth, j=mod(i−1, 16)+1, and

$$n = ⌊ \frac{i - 1}{16} ⌋ - 3.$$

In some implementations, in generating the subcarrier indices of the RU tone plan for the wide bandwidth, process 1400 may involve processor 1312 generating one or more 106-tone RUs in a 480 MHz bandwidth as:

$$R U 10 {6}_{bw 480 , i} = R U 10 {6}_{bw 80 , j} + 5 \; 12 + n * 1024.$$

In such cases, i=1, 2, 3, 4, . . . , 48 and may denote a RU index for the 480 MHz bandwidth, j=mod(i−1,8)+1, and

$$n = ⌊ \frac{i - 1}{8} ⌋ - 3.$$

In some implementations, in generating the subcarrier indices of the RU tone plan for the wide bandwidth, process 1400 may involve processor 1312 generating one or more 242-tone RUs in a 480 MHz bandwidth as:

$$R U 24 {2}_{bw 480 , i} = R U 24 {2}_{bw 80 , j} + 5 \; 12 + n * 1024.$$

In such cases, i=1, 2, 3, 4, . . . , 24 and may denote a RU index for the 480 MHz bandwidth, j=mod(i−1, 4)+1, and

$$n = ⌊ \frac{i - 1}{4} ⌋ - 3 ,$$

In some implementations, in generating the subcarrier indices of the RU tone plan for the wide bandwidth, process 1400 may involve processor 1312 generating one or more 484-tone RUs in a 480 MHz bandwidth as:

$$RU 48 {4}_{bw 4 \; 80 , i} = RU 48 {4}_{bw80 , j} + 5 \; 12 + n * 1024.$$

In such cases, i=1, 2, 3, 4, . . . , 12 and may denote a RU index for the 480 MHz bandwidth, j=mod(i−1, 2)+1, and

$$n = ⌊ \frac{i - 1}{2} ⌋ - 3.$$

In some implementations, in generating the subcarrier indices of the RU tone plan for the wide bandwidth, process 1400 may involve processor 1312 generating one or more 996-tone RUs in a 480 MHz bandwidth as:

$$RU 99 {6}_{bw 480 , i} = RU 99 {6}_{bw 80 , j} + 5 \; 12 + n * 1024.$$

In such cases, i=1, 2, 3, 4, . . . , 6 and may denote a RU index for the 480 MHz bandwidth, j=mod(i−1, 1)+1 or j=i, and or n=i−4.

$$n = ⌊ \frac{i - 1}{1} ⌋ - 3$$

In some implementations, in generating the subcarrier indices of the RU tone plan for the wide bandwidth, process 1400 may involve processor 1312 generating one or more 26-tone RUs in a 640 MHz bandwidth as:

$$RU {26}_{bw 640 , i} = RU {26}_{bw 80 , j} + 5 \; 12 + n * 1024.$$

In such cases, i=1, 2, 3, 4, . . . , 296, with i=19, 56, 93, 130, 167, 204, 241, 278 not defined, and may denote a RU index for the 640 MHz bandwidth, j=mod(i−1, 37)+1, and

$$n = ⌊ \frac{i - 1}{37} ⌋ - 4.$$

In some implementations, in generating the subcarrier indices of the RU tone plan for the wide bandwidth, process 1400 may involve processor 1312 generating one or more 52-tone RUs in a 640 MHz bandwidth as:

$$RU {52}_{bw 640 , i} = RU {52}_{bw 80 , j} + 5 \; 12 + n * 1024.$$

In such cases, i=1, 2, 3, 4, . . . , 128 and may denote a RU index for the 640 MHz bandwidth, j=mod(i−1, 16)+1, and

$$n = ⌊ \frac{i - 1}{16} ⌋ - 4.$$

In some implementations, in generating the subcarrier indices of the RU tone plan for the wide bandwidth, process 1400 may involve processor 1312 generating one or more 106-tone RUs in a 640 MHz bandwidth as:

$$RU 10 {6}_{bw 640 , i} = RU 10 {6}_{bw 80 , j} + 5 \; 12 + n * 1024.$$

In such cases, i=1, 2, 3, 4, . . . , 64 and may denote a RU index for the 640 MHz bandwidth, j=mod(i−1,8)+1, and

$$n = ⌊ \frac{i - 1}{8} ⌋ - 4.$$

In some implementations, in generating the subcarrier indices of the RU tone plan for the wide bandwidth, process 1400 may involve processor 1312 generating one or more 242-tone RUs in a 640 MHz bandwidth as:

$$RU 24 {2}_{bw 640 , i} = RU 24 {2}_{bw 80 , j} + 5 \; 12 + n * 1024.$$

In such cases, i=1, 2, 3, 4, . . . , 32 and may denote a RU index for the 640 MHz bandwidth, j=mod(i−1, 4)+1, and

$$n = ⌊ \frac{i - 1}{4} ⌋ - 4.$$

In some implementations, in generating the subcarrier indices of the RU tone plan for the wide bandwidth, process 1400 may involve processor 1312 generating one or more 484-tone RUs in a 640 MHz bandwidth as:

$$RU 48 {4}_{bw 640 , i} = RU 48 {4}_{bw 80 , j} + 5 \; 12 + n * 1024.$$

In such cases, i=1, 2, 3, 4, . . . , 16 and may denote a RU index for the 640 MHz bandwidth, j=mod(i−1, 2)+1, and

$$n = ⌊ \frac{i - 1}{2} ⌋ - 4.$$

In some implementations, in generating the subcarrier indices of the RU tone plan for the wide bandwidth, process 1400 may involve processor 1312 generating one or more 996-tone RUs in a 640 MHz bandwidth as:

$$RU 99 {6}_{b w 640 , i} = RU 99 {6}_{bw 80 , j} + 5 \; 12 + n * 1024.$$

In such cases, i=1, 2, 3, 4, . . . , 8 and may denote a RU index for the 640 MHz bandwidth, j=mod(i−1, 1)+1 or j=i, and

$$n = ⌊ \frac{i - 1}{1} ⌋ - 4$$

or n=i−5.

In some implementations, in communicating, process 1400 may involve processor 1312 communicating in a 240 MHz bandwidth and a plurality of parameters. The parameters may include: (a) T_{dft}=12.800 μs; (b) T_{gi, short}=0.800 μs; (c) T_{gi, normal}=1.600 μs; (d) T_{gi,long}=3.200 μs; (e) T_{sym}=T_{dft}+T_{gi}; (f) Fₛ=240 MHz; (g) N_{fft}=3072; (h) N_{sd}=2940; (i) Nₛₚ=48; (j) N_{dc}=23 or 5; (k) Nₛₜ=3*996; and (1) N_{guard}=(12, 11).

In some implementations, in communicating, process 1400 may involve processor 1312 communicating in a 480 MHz bandwidth and a plurality of parameters. The parameters may include: (a) T_{dft}=12.800 μs; (b) T_{gi, short}=0.800 μs; (c) T_{gi, normal}=1.600 μs; (d) T_{gi,long}=3.200 μs; (e) T_{sym}=T_{dft}+T_{gi}; (f) Fₛ=480 MHz; (g) N_{fft}=6144; (h) N_{sd}=5880; (i) Nₛₚ=96; (j) N_{dc}=23; (k) Nₛₜ=6*996; and (1) N_{guard}=(12, 11).

In some implementations, in communicating, process 1400 may involve processor 1312 communicating in a 480 MHz bandwidth and a plurality of parameters. The parameters may include: (a) T_{dft}=12.800 μs; (b) T_{gi, short}=0.800 μs; (c) T_{gi, normal}=1.600 μs; (d) T_{gi,long}=3.200 μs; (e) T_{sym}=T_{dft}+T_{gi}; (f) Fₛ=640 MHz; (g) N_{fft}=8192; (h) N_{sd}=7840; (i) Nₛₚ=128; (j) N_{dc}=23; (k) Nₛₜ=8*996; and (1) N_{guard}=(12, 11).

FIG. 15 illustrates an example process 1500 in accordance with an implementation of the present disclosure. Process 1500 may represent an aspect of implementing various proposed designs, concepts, schemes, systems and methods described above. More specifically, process 1500 may represent an aspect of the proposed concepts and schemes pertaining to wide bandwidth RU tone plan designs for next-generation WLANs in accordance with the present disclosure. Process 1500 may include one or more operations, actions, or functions as illustrated by one or more of blocks 1510 and 1520. Although illustrated as discrete blocks, various blocks of process 1500 may be divided into additional blocks, combined into fewer blocks, or eliminated, depending on the desired implementation. Moreover, the blocks/sub-blocks of process 1500 may be executed in the order shown in FIG. 15 or, alternatively in a different order. Furthermore, one or more of the blocks/sub-blocks of process 1500 may be executed repeatedly or iteratively. Process 1500 may be implemented by or in apparatus 1310 and apparatus 1320 as well as any variations thereof. Solely for illustrative purposes and without limiting the scope, process 1500 is described below in the context of apparatus 1310 implemented in or as STA 110 functioning as a non-AP STA and apparatus 1320 implemented in or as STA 120 functioning as an AP STA of a wireless network such as a WLAN in network environment 100 in accordance with one or more of IEEE 802.11 standards. Process 1500 may begin at block 1510.

At 1510, process 1500 may involve processor 1312 of apparatus 1310 generating subcarrier indices of a RU tone plan for a wide bandwidth greater than 80 MHz with a SCS of 78.125 kHz by using a formula. In an event that the RU tone plan pertains to a 240 MHz bandwidth, the RU tone plan may involve puncturing a contiguous 80 MHz bandwidth from a 320 MHz bandwidth. In an event that the RU tone plan pertains to a 480 MHz bandwidth, the RU tone plan may involve puncturing a contiguous 160 MHz bandwidth from a 640 MHz bandwidth. Process 1500 may proceed from 1510 to 1520.

At 1520, process 1500 may involve processor 1312 communicating, via transceiver 1316, wirelessly in the wide bandwidth (e.g., transmitting to and/or receiving from apparatus 1320).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, subcarrier indices of a resource unit (RU) tone plan for a wide bandwidth greater than 80 MHz with a subcarrier spacing (SCS) of 78.125 kHz by using a formula; and
communicating, by the processor, wirelessly in the wide bandwidth.

2. The method of claim 1, wherein the generating of the subcarrier indices of the RU tone plan for the wide bandwidth comprises generating the subcarrier indices as:
$$R {U}_{wbw , i} = R {U}_{bw 80 , j} + 5 \; 12 + n * 1024 ,$$
wherein:
i=1, 2, 3, 4, . . . , N_{ru,bw} and denotes a RU index for the wide bandwidth,
j=mod(i−1, N_{ru,bw80})+1 and denotes a RU index for an 80 MHz bandwidth,
$$n = ⌊ \frac{i - 1}{{N}_{ru , bw 80}} ⌋ - \frac{B W}{2 * 80} ,$$
RU_{wbw,i} denotes subcarrier indices for a respective RU type in the wide bandwidth with a RU index i,
RU_{bw80,j} denotes subcarrier indices for a respective RU type in an 80 MHz bandwidth with a RU index j, and
N_{ru,bw} denotes a number of RUs for the respective RU type in a respective bandwidth.

3. The method of claim 2, wherein the generating of the subcarrier indices of the RU tone plan for the wide bandwidth comprises generating one or more 26-tone RUs in a 480 MHz bandwidth as:
$$R U 2 {6}_{bw 480 , i} = R U 2 {6}_{bw 80 , j} + 5 \; 12 + n * 1024 ,$$
wherein:
i=1, 2, 3, 4, . . . , 222, with i=19, 56, 93, 130, 167, 204 not defined, and denotes a RU index for the 480 MHz bandwidth,
$$\begin{matrix}j = mod ( i - 1 , 37 ) + 1 , and \\ n = ⌊ \frac{i - 1}{37} ⌋ - 3.\end{matrix}$$

4. The method of claim 2, wherein the generating of the subcarrier indices of the RU tone plan for the wide bandwidth comprises generating one or more 52-tone RUs in a 480 MHz bandwidth as:
$$R U 5 {2}_{bw 480 , i} = R U 5 {2}_{bw 80 , j} + 5 \; 12 + n * 1024 ,$$
wherein:
i=1, 2, 3, 4, . . . , 96 and denotes a RU index for the 480 MHz bandwidth,
$$\begin{matrix}j = mod ( i - 1 , 16 ) + 1 , and \\ n = ⌊ \frac{i - 1}{16} ⌋ - 3.\end{matrix}$$

5. The method of claim 2, wherein the generating of the subcarrier indices of the RU tone plan for the wide bandwidth comprises generating one or more 106-tone RUs in a 480 MHz bandwidth as:
$$R U 10 {6}_{bw 4 \; 80 , i} = R U 10 {6}_{bw 80 , j} + 5 \; 12 + n * 1024 ,$$
wherein:
i=1, 2, 3, 4, . . . , 48 and denotes a RU index for the 480 MHz bandwidth,
$$\begin{matrix}j = mod ( i - 1 , 8 ) + 1 , and \\ n = ⌊ \frac{i - 1}{8} ⌋ - 3.\end{matrix}$$

6. The method of claim 2, wherein the generating of the subcarrier indices of the RU tone plan for the wide bandwidth comprises generating one or more 242-tone RUs in a 480 MHz bandwidth as:
$$R U 24 {2}_{bw 480 , i} = R U 24 {2}_{bw 80 , j} + 5 \; 12 + n * 1024 ,$$
wherein:
i=1, 2, 3, 4, . . . , 24 and denotes a RU index for the 480 MHz bandwidth,
$$\begin{matrix}j = mod ( i - 1 , 4 ) + 1 , and \\ n = ⌊ \frac{i - 1}{4} ⌋ - 3.\end{matrix}$$

7. The method of claim 2, wherein the generating of the subcarrier indices of the RU tone plan for the wide bandwidth comprises generating one or more 484-tone RUs in a 480 MHz bandwidth as:
$$R U 48 {4}_{bw 480 , i} = R U 48 {4}_{bw 80 , j} + 5 \; 12 + n * 1024 ,$$
wherein:
i=1, 2, 3, 4, . . . , 12 and denotes a RU index for the 480 MHz bandwidth,
$$\begin{matrix}j = mod ( i - 1 , 2 ) + 1 , and \\ n = ⌊ \frac{i - 1}{2} ⌋ - 3.\end{matrix}$$

8. The method of claim 2, wherein the generating of the subcarrier indices of the RU tone plan for the wide bandwidth comprises generating one or more 996-tone RUs in a 480 MHz bandwidth as:
$$R U 99 {6}_{bw 480 , i} = R U 99 {6}_{bw 80 , j} + 5 \; 12 + n * 1024 ,$$
wherein:
i=1, 2, 3, 4, . . . , 6 and denotes a RU index for the 480 MHz bandwidth,
$$\begin{matrix}j = mod ( i - 1 , 1 ) + 1 or j = i , and \\ n = ⌊ \frac{i - 1}{1} ⌋ - 3 or n = i - 4 .\end{matrix}$$

9. The method of claim 2, wherein the generating of the subcarrier indices of the RU tone plan for the wide bandwidth comprises generating one or more 26-tone RUs in a 640 MHz bandwidth as:
$$R U 2 {6}_{b w 640 , i} = R U 2 {6}_{bw 80 , j} + 5 \; 12 + n * 1024 ,$$
wherein:
i=1, 2, 3, 4, . . . , 296, with i=19, 56, 93, 130, 167, 204, 241, 278 not defined, and denotes a RU index for the 640 MHz bandwidth,
$$\begin{matrix}j = mod ( i - 1 , 37 ) + 1 , and \\ n = ⌊ \frac{i - 1}{37} ⌋ - 4.\end{matrix}$$

10. The method of claim 2, wherein the generating of the subcarrier indices of the RU tone plan for the wide bandwidth comprises generating one or more 52-tone RUs in a 640 MHz bandwidth as:
$$R U 5 {2}_{b w 640 , i} = R U 5 {2}_{bw 80 , j} + 5 \; 12 + n * 1024 ,$$
wherein:
i=1, 2, 3, 4, . . . , 128 and denotes a RU index for the 640 MHz bandwidth,
$$\begin{matrix}j = mod ( i - 1 , 16 ) + 1 , and \\ n = ⌊ \frac{i - 1}{16} ⌋ - 4.\end{matrix}$$

11. The method of claim 2, wherein the generating of the subcarrier indices of the RU tone plan for the wide bandwidth comprises generating one or more 106-tone RUs in a 640 MHz bandwidth as:
$$R U 10 {6}_{b w 640 , i} = R U 10 {6}_{bw 80 , j} + 5 \; 12 + n * 1024 ,$$
wherein:
i=1, 2, 3, 4, . . . , 64 and denotes a RU index for the 640 MHz bandwidth,
$$\begin{matrix}j = mod ( i - 1 , 8 ) + 1 , and \\ n = ⌊ \frac{i - 1}{8} ⌋ - 4.\end{matrix}$$

12. The method of claim 2, wherein the generating of the subcarrier indices of the RU tone plan for the wide bandwidth comprises generating one or more 242-tone RUs in a 640 MHz bandwidth as:
$$RU {242}_{b w 640 , i} = RU {242}_{bw 80 , j} + 5 \; 12 + n * 1024 ,$$
wherein:
i=1, 2, 3, 4, . . . , 32 and denotes a RU index for the 640 MHz bandwidth,
$$\begin{matrix}j = mod ( i - 1 , 4 ) + 1 , and \\ n = ⌊ \frac{i - 1}{4} ⌋ - 4.\end{matrix}$$

13. The method of claim 2, wherein the generating of the subcarrier indices of the RU tone plan for the wide bandwidth comprises generating one or more 484-tone RUs in a 640 MHz bandwidth as:
$$RU {484}_{b w 640 , i} = RU {484}_{bw 80 , j} + 5 \; 12 + n * 1024 ,$$
wherein:
i=1, 2, 3, 4, . . . , 16 and denotes a RU index for the 640 MHz bandwidth,
$$\begin{matrix}j = mod ( i - 1 , 2 ) + 1 , and \\ n = ⌊ \frac{i - 1}{2} ⌋ - 4.\end{matrix}$$

14. The method of claim 2, wherein the generating of the subcarrier indices of the RU tone plan for the wide bandwidth comprises generating one or more 996-tone RUs in a 640 MHz bandwidth as:
$$RU {996}_{b w 640 , i} = RU {996}_{bw 80 , j} + 5 \; 12 + n * 1024 ,$$
wherein:
i=1, 2, 3, 4, . . . , 8 and denotes a RU index for the 640 MHz bandwidth,
$$\begin{matrix}j = mod ( i - 1 , 1 ) + 1 or j = i , and \\ n = ⌊ \frac{i - 1}{1} ⌋ - 4 or n = i - 5.\end{matrix}$$

15. The method of claim 1, wherein the communicating comprises communicating in a 240 MHz bandwidth and a plurality of parameters comprising:
a discrete Fourier transform (DFT) period (T_{dft}) of 12.800 μs;
a short guard interval (GI) duration (T_{gi, short}) of 0.800 μs;
a normal GI duration (T_{gi, normal}) of 1.600 μs;
a long GI duration (T_{gi, long}) of 3.200 μs;
an orthogonal frequency-division multiplexing (OFDM) symbol duration (T_{sym})=T_{dft}+T_{gi};
a sampling frequency (Fₛ) of 240 MHz;
a number of fast Fourier transform (FFT) subcarriers (N_{fft}) of 3072;
a number of data-carrying subcarriers (N_{sd}) of 2940;
a number of pilot-tone subcarriers (Nₛₚ) of 48;
a number of direct-current (DC) tones (N_{dc}) of 23 or 5;
a total number of subcarriers (Nₛₜ) of 3*996; and
a number of guard tones left and right (N_{guard})=(12, 11).

16. The method of claim 1, wherein the communicating comprises communicating in a 480 MHz bandwidth and a plurality of parameters comprising:
a discrete Fourier transform (DFT) period (T_{dft}) of 12.800 μs;
a short guard interval (GI) duration (T_{gi, short}) of 0.800 μs;
a normal GI duration (T_{gi, normal}) of 1.600 μs;
a long GI duration (T_{gi, long}) of 3.200 μs;
an orthogonal frequency-division multiplexing (OFDM) symbol duration (T_{sym})=T_{dft}+T_{gi};
a sampling frequency (Fₛ) of 480 MHz;
a number of fast Fourier transform (FFT) subcarriers (N_{fft}) of 6144;
a number of data-carrying subcarriers (N_{sd}) of 5880;
a number of pilot-tone subcarriers (Nₛₚ) of 96;
a number of direct-current (DC) tones (N_{dc}) of 23;
a total number of subcarriers (Nₛₜ) of 6*996; and
a number of guard tones left and right (N_{guard})=(12, 11).

17. The method of claim 1, wherein the communicating comprises communicating in a 640 MHz bandwidth and a plurality of parameters comprising:
a discrete Fourier transform (DFT) period (Taft) of 12.800 μs;
a short guard interval (GI) duration (T_{gi, short}) of 0.800 μs;
a normal GI duration (T_{gi, normal}) of 1.600 μs;
a long GI duration (T_{gi, long}) of 3.200 μs;
an orthogonal frequency-division multiplexing (OFDM) symbol duration (T_{sym})=T_{dft}+T_{gi};
a sampling frequency (Fₛ) of 640 MHz;
a number of fast Fourier transform (FFT) subcarriers (N_{fft}) of 8192;
a number of data-carrying subcarriers (N_{sd}) of 7840;
a number of pilot-tone subcarriers (Nₛₚ) of 128;
a number of direct-current (DC) tones (N_{dc}) of 23;
a total number of subcarriers (Nₛₜ) of 8*996; and
a number of guard tones left and right (N_{guard})=(12, 11).

18. A method, comprising:
generating, by a processor of an apparatus, subcarrier indices of a resource unit (RU) tone plan for a wide bandwidth greater than 80 MHz with a subcarrier spacing (SCS) of 78.125 kHz by using a formula; and
communicating, by the processor, wirelessly in the wide bandwidth,
wherein, in an event that the RU tone plan pertains to a 240 MHz bandwidth, the RU tone plan comprises puncturing a contiguous 80 MHz bandwidth from a 320 MHz bandwidth, and
wherein, in an event that the RU tone plan pertains to a 480 MHz bandwidth, the RU tone plan comprises puncturing a contiguous 160 MHz bandwidth from a 640 MHz bandwidth.

19. An apparatus, comprising:
a transceiver configured to communicate wirelessly; and
a processor coupled to the transceiver and configured to perform operations comprising:
generating subcarrier indices of a resource unit (RU) tone plan for a wide bandwidth greater than 80 MHz with a subcarrier spacing (SCS) of 78.125 kHz by using a formula; and
communicating, via the transceiver, wirelessly in the wide bandwidth, wherein the wide bandwidth comprises a 240 MHz, 480 MHz or 640 MHz bandwidth.

20. The apparatus of claim 19, wherein the generating of the subcarrier indices of the RU tone plan for the wide bandwidth comprises generating the subcarrier indices as:
$$R {U}_{wbw , i} = R {U}_{bw 80 , j} + 5 \; 12 + n * 1024 ,$$
wherein:
i=1, 2, 3, 4, . . . , N_{ru,bw} and denotes a RU index for the wide bandwidth,
j=mod(i−1, N_{ru,bw80})+1 and denotes a RU index for an 80 MHz bandwidth,
$$n = ⌊ \frac{i - 1}{{N}_{ru , bw 80}} ⌋ - \frac{B W}{2 * 80} ,$$
RU_{wbw,i} denotes subcarrier indices for a respective RU type in the wide bandwidth with a RU index i,
RU_{bw80,j} denotes subcarrier indices for a respective RU type in an 80 MHz bandwidth with a RU index j, and
N_{ru,bw} denotes a number of RUs for the respective RU type in a respective bandwidth.
